(19) United States
(12) Patent Application Publication
(10) Pub. No.: US 2011/0041177 A1
(43) Pub. Date: Feb. 17, 2011

(54) CONTEXT-SENSITIVE INPUT USER INTERFACE

(75) Inventor: Jorge PEREIRA, Seattle, WA (US)

Correspondence Address: MERCHANT & GOULD (MICROSOFT), P.O. BOX 2903, MINNEAPOLIS, MN, 55402-0903, US

(73) Assignee: MICROSOFT CORPORATION, Redmond, WA (US)

(21) Appl. No.: 12/541,819

(22) Filed: Aug. 14, 2009

(51) Int. Cl. H04L 9/32

(52) U.S. Cl. 726/20

(57) ABSTRACT

A context-sensitive user input interface may be provided. An application may display a user interface element, such as a text box. The interface may provide suggested action tokens, and may receive a user selection of one of the suggested tokens and/or a text-based input of an action token. The interface may also provide suggested options and/or guidance to the user in entering an application action. The interface may further determine when the user's input comprises a complete action and may provide an execute option to the user for finalizing and executing the action.

### BACKGROUND

Context-sensitive input user interface is a process for allowing users to communicate actions to a software application. In some situations, users may wish to perform actions in an application that can be difficult to discover or may not be intuitive to use. For example, finding application settings can often involve selecting several different menu options before the proper command can be found. Thus, the conventional strategy often results in a user interface that lacks context-sensitivity or ease of searching.

### SUMMARY

This Summary is provided to introduce a selection of concepts in a simplified form that are further described below in the Detailed Description. This Summary is not intended to identify key features or essential features of the claimed subject matter. Nor is this Summary intended to be used to limit the claimed subject matter's scope.

A context-sensitive user input interface may be provided. An application may display a user interface element, such as a text box. The interface may provide suggested action tokens, and may receive a user selection of one of the suggested tokens and/or a text-based input of an action token. The interface may also provide suggested options and/or guidance to the user in entering an application action. The interface may further determine when the user's input comprises a complete action and may provide an execute option to the user for finalizing and executing the action.

Both the foregoing general description and the following detailed description provide examples and are explanatory only. Accordingly, the foregoing general description and the following detailed description should not be considered to be restrictive. Further, features or variations may be provided in addition to those set forth herein. For example, embodiments may be directed to various feature combinations and sub-combinations described in the detailed description.

### BRIEF DESCRIPTION OF THE DRAWINGS

The accompanying drawings, which are incorporated in and constitute a part of this disclosure, illustrate various embodiments of the present invention. In the drawings:

FIG. 1 is a block diagram of an operating environment;

FIG. 2 is a flow chart of a method for providing a context-sensitive user interface input;

FIGS. 3A through 3F are a series of block diagrams of a user interface for providing a context-sensitive input; and

FIG. 4 is a block diagram of a system including a computing device.

### DETAILED DESCRIPTION

The following detailed description refers to the accompanying drawings. Wherever possible, the same reference numbers are used in the drawings and the following description to refer to the same or similar elements. While embodiments of the invention may be described, modifications, adaptations, and other implementations are possible. For example, substitutions, additions, or modifications may be made to the elements illustrated in the drawings, and the methods described herein may be modified by substituting, reordering, or adding stages to the disclosed methods. Accordingly, the following detailed description does not limit the invention. Instead, the proper scope of the invention is defined by the appended claims.

A context-sensitive user interface input may be provided. Consistent with embodiments of the present invention, a user interface element comprising text input may be provided as part of an application user interface (UI). The UI element may comprise graphical assistance presented to a user as they type to aid in building an application action. The action input may be grammar driven, so that as user types, actions sentences may be built according to a pre-defined grammar and/or a natural language action. For example, a predefined grammar action may comprise “Search—from: John Doe sent: 05/01/09-05/31/09” while a natural language action may comprise “find all e-mails I received from John in May.” The UI element may provide context-sensitive suggestions; that is, given what the element knows about the user's context (e.g. an application focus such as a calendar or an email function and what the user has typed already), the control may offer different options and/or suggestions as to what the user may enter next.

The user interface control may comprise a text-box in which the user may type actions. Actions may comprise “sentences” that may follow a grammar defined by the application. As the user enters “token” (words) and builds the action, a graphical user interface may follow the text caret and may provide suggestions on tokens that may be typed next and/or selected to continue to build the action. Once the user is done, a completed executable action may be sent to the application for processing.

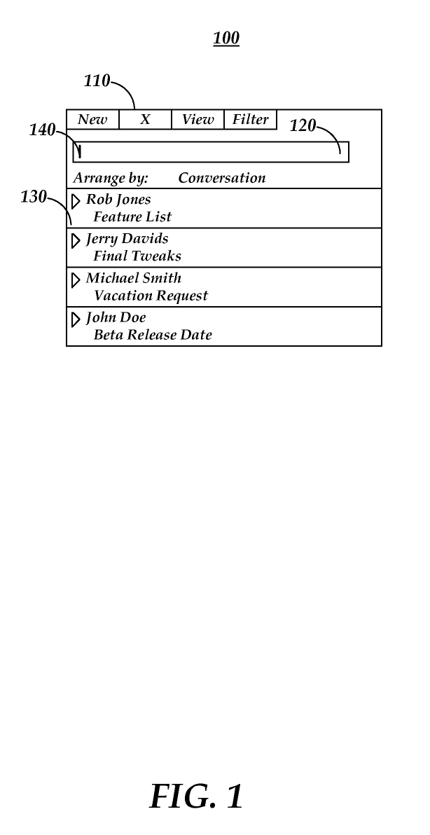

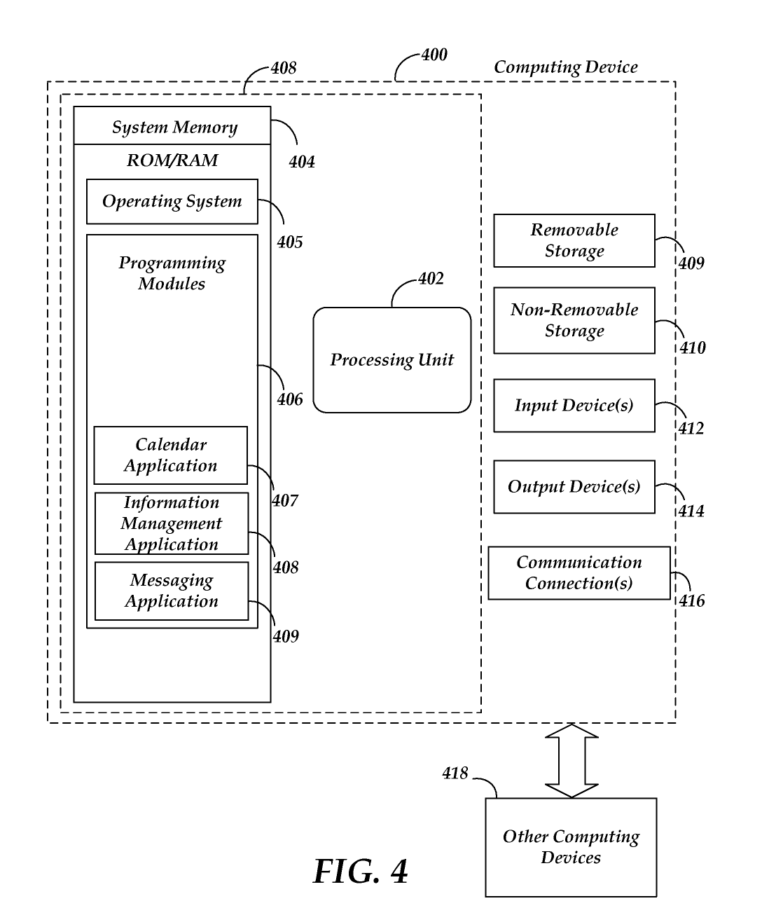

FIG. 1 is a block diagram of a user interface 100. User interface (UI) 100 may comprise an interface associated with a software application executing on a computer, such as a computing device 400 as described below in greater detail with respect to FIG. 4. UI 100 may comprise a menu bar 110, an action input 120, and an application data interface 130. Action input 120 may comprise a caret 140 for identifying a current text input location. Application data interface 130 may comprise, for example, a list of e-mail messages in an e-mail application, a list of to-do items, a calendar showing upcoming appointments, and/or other types of data associated with various applications.

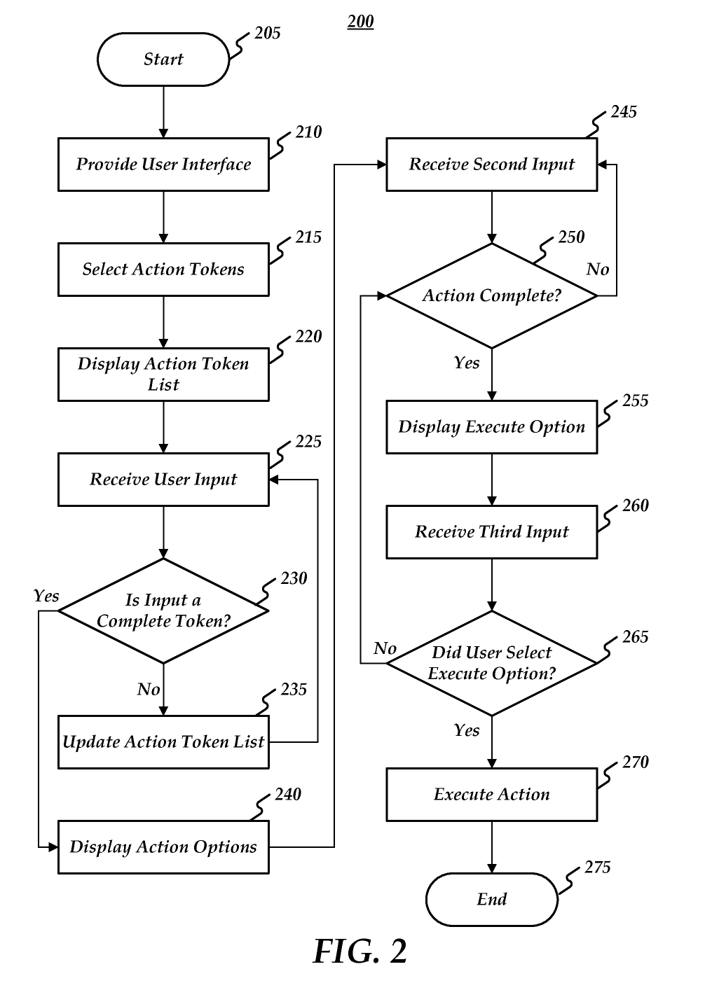

FIG. 2 is a flow chart setting forth the general stages involved in a method 200 consistent with an embodiment of the invention for providing a context-sensitive user input interface. Method 200 may be implemented using a computing device 400 as described in more detail below with respect to FIG. 4. Ways to implement the stages of method 200 will be described in greater detail below. Method 200 may begin at starting block 205 and proceed to stage 210 where computing device 400 may provide a text input user interface element in an application. For example, an e-mail application may provide a text box situated above a list of e-mail messages.

From stage 210, method 200 may advance to stage 215 where computing device 400 may select action tokens from a list of action tokens associated with the application. Computing device 300 may identify a currently active function of the application and select action tokens associated with the currently active function. For example, a personal information management application may determine whether a user is currently viewing a list of contacts, a list of messages, or a calendar. The application may then select action tokens associated with the currently active function such as creating or searching messages of the message list and creating a meeting request for the calendar. The application may comprise a predefined grammar list for any and/or all user commands, such as menu options, application settings, and/or functions. Users may add tokens to the grammar list and/or remove action tokens from the list. Consistent with embodiments of the invention, the list of selected tokens may comprise any and/or all of the tokens of the predefined grammar.

Method 200 may then advance to stage 220 where computing device 400 may display the selected action tokens in a context menu. The context menu may be displayed proximate to the user interface element, such as adjacent to a current text input location. The current input location may advance as the user types in the element and/or selects tokens from the context menu, and the menu may move accordingly.

From stage 220, method 200 may advance to stage 225 where computing device 400 may receive an input from a user. For example, the user may type one and/or more characters in the text box and/or select one of the displayed action tokens from the context menu. Consistent with embodiments of the invention, the user may enter characters comprising a portion of one of the action tokens and select the matching action token using a mouse and/or keyboard input.

Upon receiving the user input, method 200 may advance to stage 230 where computing device 400 may determine whether the input comprises a complete action token. For example, displayed action tokens may comprise “New Message,” “Search Messages,” and “Search Contacts.” The user may type the word “search” and computing device 400 may determine that the input is not a complete token.

If the input does not comprise a complete action token, method 200 may advance to stage 235 where computing device 400 may update the display of the action tokens. For example, the context menu may be contracted to display a subset of the action tokens that match the input. With an input of “search”, the “New Message” option may be removed from the context menu leaving the “Search Messages” and “Search Contacts” options. Method 200 may then return to stage 225 where computing device 400 may receive further input from the user.

If, at stage 230, computing device 400 determines that the input does comprise a complete action token, the application may display a list of options associated with the action token. For example, if the user inputs a complete token of “Search Messages,” the context menu may display a list of search options such as “from,” “to,” and/or “date sent.”

After displaying the action options associated with the completed action token at stage 240, method 200 may advance to stage 245 where computing device 400 may receive a second input from the user. For example, the user may select the “date sent” option.

Method 200 may then advance to stage 250, where computing device 400 may determine whether the user has input a complete action. For example, if the user has input “Search Messages date sent,” computing device 400 may determine that the user may still need to enter a date range for the “date sent” option and may return to stage 245 to receive further input.

Otherwise, method 200 may advance to stage 255 where computing device 400 may display an execute option in the context menu. For example, the context menu may display other options for the selected action token, such as “from” and “to” for the “Search Messages” option and a “Search Now!” entry to execute the command as input.

Method 200 may then advance to stage 260 where computing device 400 may receive another input from the user. For example, the user may type and/or select the “Search Now!” entry. Computing device 400 may then determine whether the user input comprises a selection of the execute option at stage 265. If not, such as if the user input another action option, method 200 may return to stage 250. Otherwise, method 200 may advance to stage 270 where computing device 400 may execute the finalized action. For example, the application may search for messages matching the options input by the user and display them. Consistent with embodiments of the invention, the user may edit, rearrange, delete, and/or otherwise modify previously entered tokens and/or options. Suggested tokens and options may then be associated with the modified tokens and/or options. Method 200 may then end at stage 275.

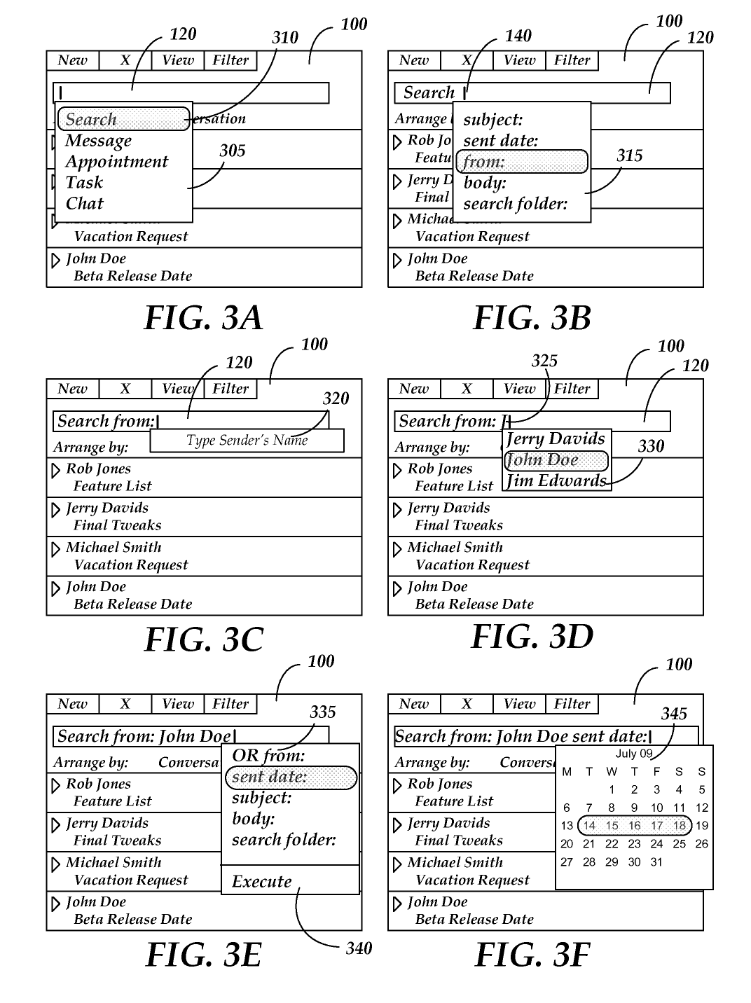

FIGS. 3A-3F comprise a series of block diagrams of user interface (UI) 100 for providing a context-sensitive input. FIG. 3A comprises user interface 100 and action input 120. UI 100 may display an initial token list 310, such as in response to receiving focus in action input 120. Initial token list 310 may comprise a contextual graphical interface that may follow the user's text input and provide suggestions on what tokens may be selected and/or typed next. This may help users learn the grammar and provide a selection option for users who prefer the mouse to typing. A typed and/or selected option 310 may be inserted into action input 120. For example, a user may select a “Search” token in an e-mail application to begin constructing a search action operative to search through contacts and/or e-mails.

FIG. 3B comprises user interface 100 with a first action token displayed in action input 120. A second context menu 315 may be displayed with suggestions for a second action token associated with the first action token. For example, the first token may comprise “Search” and second action token options may comprise criteria associated with a search, such as “subject”, “sent date”, “from”, “body”, and “search folder”. Consistent with embodiments of the invention, second context menu 315 may follow caret 140 displaying proximate to the current text input location as the user types.

At each stage of building the action sentence, the context menu may be displayed with suggestions and/or instructions so that the user is never left alone to guess what should be typed next. For example, FIG. 3C illustrates user interface 100 with two action tokens, “search” and “from:” displayed in action input 120. A context instruction 320 may be displayed proximate to caret 140 for providing guidance to the user as to what may be typed next. In this case, the user is prompted to enter a contact's name for the search. FIG. 3D illustrates a first character 325 entered by a user in action input 120 and a contact suggestion menu 330 displaying matching contacts. The user may then type and/or select one of the names displayed in contact suggestion menu 300 or may enter a different name from those displayed. Action tokens may also be restricted as the user types; for example, in FIG. 3B, if the user typed the letter “s”, second action token list 315 may reduce the list of suggested action tokens to “subject”, “sent date”, and “search folder”.

FIG. 3E comprises user interface 100 with the action sentence as constructed displayed in action input 120. A third context menu 335 may be displayed with suggestions for an additional action token associated with the action sentence. For the Search example, additional search criteria may be displayed for the user to type and/or select. Consistent with embodiments of the invention, third context menu 335 may display a finalize option, such as an “Execute” action 340. The user may select “Execute” action 340 in order to finalize and perform the action sentence.

FIG. 3F comprises user interface 100 with a calendar display 340 to aid the user in selecting a date and/or plurality of dates for an action token comprising a date criteria to a search action. For example, the user may view the calendar as a reference while typing a date and/or select one and/or more dates in calendar display 340. Consistent with embodiments of the invention, context menus may display textual and/or graphical elements as suggestions and/or action tokens.

The user may move caret 140 around to go back and modify parts of the action before it's completed. For example, the user may click on “John Dow”, delete the name, and search for messages associated with a different contact. Keys, such as “tab” and/or “enter” may be assigned to apply a selected item in the context menu.

Since the grammar that allows the user to describe every action possible in an application may be huge, context-sensitivity is important. The grammar list may be restricted to those actions that make sense to data the user has selected. For example, if the user has selected a calendar appointment, initial token list 310 may be populated with tokens associated with calendar applications, such as creating a new appointment, modifying an existing appointment, and/or sending a meeting request.

Action input 120 may be used in many places in an application. For example, for an email application, it may be constantly displayed on top of a list of e-mail messages, while action input 120 may show up when a user selects calendar item in a scheduling/appointment application and disappear when no item is selected. The grammar available may depend on the data with which the control is associated. So, in the calendar example, the actions may relate to a calendar item itself, such as changing the location, the start time, etc. The control may respond to what the user types in and may use a plurality of tokens, so if the user types “5”, a month display such as calendar display 340 may switch to show the month of May, while a user may also be able to type a specific date and/or a descriptor such as “yesterday”, “today”, or “last month” and have the control understand these. Other context control examples may comprise a tree control displaying a tree of the hard drive folder hierarchy to manipulate files, a list of thumbnail images, and/or a color picker. If the user needs to pick a color, she can type the RGB values or pick it from a color picker UI (like the standard one in Windows).

For another example, action input 120 may be used for finding and/or changing options and settings in an application. Rather than forcing a user to navigate a series of pages, dialogues, and/or menus until the user finds the desired option, a context sensitive UI may allow ease of searching application options. For example, if a user wants to change an email signature, the user may select action input 120 and type and/or select a “change setting” token. A context menu may then display a list of available options to change that may be limited based on context. Even if the list is large, the user may type “signature” and the list may be filtered to display “change signature” (if the user already has one) and/or “add signature” (if the user doesn't). This latter is another example of context sensitivity, and how the control may rephrase the actions depending on what it already knows about the user. Consistent with embodiments of the invention, action input 120 may also receive tokens representing commands for the application and may be operative to execute application controls without the user needing to select the controls from a menu or ribbon UI.

The tokens input by the user may translate actions into command sentences. These sentences may be copied and pasted, such as when sent by support personnel. For example, a support response may comprise a text sentence to a user being assisted (e.g. “change resolution to 1024×768”) that may be pasted into action input 120 rather than guiding the user through a series of mouse clicks and dialogues. Saved sentences may also be saved for later use as macros. Consistent with embodiments of the invention, available and/or suggested options and tokens may be read aloud to a user, and the user may speak the tokens he wants to enter.

An embodiment consistent with the invention may comprise a system for providing a context-sensitive user interface. The system may comprise a memory storage and a processing unit coupled to the memory storage. The processing unit may be operative to display an input element in an application, receive a first text input in the input element, determine whether the first text input comprises an action token, and in response to determining that the first text input comprises an action token, provide at least one suggested option associated with the action token to the user. If the text input does not comprise an action token, the system may determine if the input is a partial match for any action tokens and display a list of the matching tokens. Suggested options may comprise text, graphics, and/or both (e.g. an icon accompanied by a textual description). Action tokens may be selected from a list of grammar terms associated with the application and may be specific to a user interface language (e.g., separate grammar lists for English, Arabic, French, etc.)

Another embodiment consistent with the invention may comprise a system for providing a context-sensitive user interface. The system may comprise a memory storage and a processing unit coupled to the memory storage. The processing unit may be operative to display a user interface element associated with an application, provide at least one suggested action token, receive a text input, determine whether the text input comprises a complete action, and in response to determining that the text input does not comprise a complete action, provide at least one suggested option to the user. If the text input does comprise a complete action, the system may provide an option to execute the action. Consistent with embodiments of the invention, the action may comprise, for example, a search action, a setting change, a data element creation, and a data element modification. Completed actions may also be saved for re-use.

Yet another embodiment consistent with the invention may comprise a system for providing a context-sensitive user input. The system may comprise a memory storage and a processing unit coupled to the memory storage. The processing unit may be operative to provide a text input user interface element, select a plurality of action tokens from a list of action tokens associated with the application, display the action tokens in a context menu, receive a first input from a user, and determine whether the input comprises a complete action token. The selected action tokens may be associated with the currently active function, such as a calendar function in an information management application. If the input does not comprise a complete action token, the system may update the action token display to display a subset of the plurality of action tokens that match the input. If the input is a complete action token, the system may display a plurality of action options associated with the action token, receive a second input from the user, and determine whether the first input and the second input comprise a completed action. If a complete action has been input, the system may display an execute option, receive a third input from the user, determine whether the third input comprises a selection of the execute option, and in response to determining that the third input comprises a selection of the execute option, execute the completed action.

FIG. 4 is a block diagram of a system including computing device 400. Consistent with an embodiment of the invention, the aforementioned memory storage and processing unit may be implemented in a computing device, such as computing device 400 of FIG. 4. Any suitable combination of hardware, software, or firmware may be used to implement the memory storage and processing unit. For example, the memory storage and processing unit may be implemented with computing device 400 or any of other computing devices 418, in combination with computing device 400. The aforementioned system, device, and processors are examples and other systems, devices, and processors may comprise the aforementioned memory storage and processing unit, consistent with embodiments of the invention. Furthermore, computing device 400 may comprise an operating environment for system 100 as described above. System 100 may operate in other environments and is not limited to computing device 400.

With reference to FIG. 4, a system consistent with an embodiment of the invention may include a computing device, such as computing device 400. In a basic configuration, computing device 400 may include at least one processing unit 402 and a system memory 404. Depending on the configuration and type of computing device, system memory 404 may comprise, but is not limited to, volatile (e.g. random access memory (RAM)), non-volatile (e.g. read-only memory (ROM)), flash memory, or any combination. System memory 404 may include operating system 405 and one or more programming modules 406. Operating system 405, for example, may be suitable for controlling computing device 400's operation. Programming modules 406 may include applications such as a calendar application 407, an information management application 408, and/or a messaging application 409. Furthermore, embodiments of the invention may be practiced in conjunction with a graphics library, other operating systems, or any other application program and is not limited to any particular application or system. This basic configuration is illustrated in FIG. 4 by those components within a dashed line 408.

Computing device 400 may have additional features or functionality. For example, computing device 400 may also include additional data storage devices (removable and/or non-removable) such as, for example, magnetic disks, optical disks, or tape. Such additional storage is illustrated in FIG. 4 by a removable storage 409 and a non-removable storage 410. Computer storage media may include volatile and nonvolatile, removable and non-removable media implemented in any method or technology for storage of information, such as computer readable instructions, data structures, program modules, or other data. System memory 404, removable storage 409, and non-removable storage 410 are all computer storage media examples (i.e memory storage.) Computer storage media may include, but is not limited to, RAM, ROM, electrically erasable read-only memory (EEPROM), flash memory or other memory technology, CD-ROM, digital versatile disks (DVD) or other optical storage, magnetic cassettes, magnetic tape, magnetic disk storage or other magnetic storage devices, or any other medium which can be used to store information and which can be accessed by computing device 400. Any such computer storage media may be part of device 400. Computing device 400 may also have input device(s) 412 such as a keyboard, a mouse, a pen, a sound input device, a touch input device, etc. Output device(s) 414 such as a display, speakers, a printer, etc. may also be included. The aforementioned devices are examples and others may be used.

Computing device 400 may also contain a communication connection 416 that may allow device 400 to communicate with other computing devices 418, such as over a network in a distributed computing environment, for example, an intranet or the Internet. Communication connection 416 is one example of communication media. Communication media may typically be embodied by computer readable instructions, data structures, program modules, or other data in a modulated data signal, such as a carrier wave or other transport mechanism, and includes any information delivery media. The term “modulated data signal” may describe a signal that has one or more characteristics set or changed in such a manner as to encode information in the signal. By way of example, and not limitation, communication media may include wired media such as a wired network or direct-wired connection, and wireless media such as acoustic, radio frequency (RF), infrared, and other wireless media. The term computer readable media as used herein may include both storage media and communication media.

As stated above, a number of program modules and data files may be stored in system memory 404, including operating system 405. While executing on processing unit 402, programming modules 406 may perform processes including, for example, one or more of method 200's stages as described above. The aforementioned process is an example, and processing unit 402 may perform other processes. Other programming modules that may be used in accordance with embodiments of the present invention may include electronic mail and contacts applications, word processing applications, spreadsheet applications, database applications, slide presentation applications, drawing or computer-aided application programs, etc.

Generally, consistent with embodiments of the invention, program modules may include routines, programs, components, data structures, and other types of structures that may perform particular tasks or that may implement particular abstract data types. Moreover, embodiments of the invention may be practiced with other computer system configurations, including hand-held devices, multiprocessor systems, microprocessor-based or programmable consumer electronics, minicomputers, mainframe computers, and the like. Embodiments of the invention may also be practiced in distributed computing environments where tasks are performed by remote processing devices that are linked through a communications network. In a distributed computing environment, program modules may be located in both local and remote memory storage devices.

Furthermore, embodiments of the invention may be practiced in an electrical circuit comprising discrete electronic elements, packaged or integrated electronic chips containing logic gates, a circuit utilizing a microprocessor, or on a single chip containing electronic elements or microprocessors. Embodiments of the invention may also be practiced using other technologies capable of performing logical operations such as, for example, AND, OR, and NOT, including but not limited to mechanical, optical, fluidic, and quantum technologies. In addition, embodiments of the invention may be practiced within a general purpose computer or in any other circuits or systems.

Embodiments of the invention, for example, may be implemented as a computer process (method), a computing system, or as an article of manufacture, such as a computer program product or computer readable media. The computer program product may be a computer storage media readable by a computer system and encoding a computer program of instructions for executing a computer process. The computer program product may also be a propagated signal on a carrier readable by a computing system and encoding a computer program of instructions for executing a computer process. Accordingly, the present invention may be embodied in hardware and/or in software (including firmware, resident software, micro-code, etc.). In other words, embodiments of the present invention may take the form of a computer program product on a computer-usable or computer-readable storage medium having computer-usable or computer-readable program code embodied in the medium for use by or in connection with an instruction execution system. A computer-usable or computer-readable medium may be any medium that can contain, store, communicate, propagate, or transport the program for use by or in connection with the instruction execution system, apparatus, or device.

The computer-usable or computer-readable medium may be, for example but not limited to, an electronic, magnetic, optical, electromagnetic, infrared, or semiconductor system, apparatus, device, or propagation medium. More specific computer-readable medium examples (a non-exhaustive list), the computer-readable medium may include the following: an electrical connection having one or more wires, a portable computer diskette, a random access memory (RAM), a read-only memory (ROM), an erasable programmable read-only memory (EPROM or Flash memory), an optical fiber, and a portable compact disc read-only memory (CD-ROM). Note that the computer-usable or computer-readable medium could even be paper or another suitable medium upon which the program is printed, as the program can be electronically captured, via, for instance, optical scanning of the paper or other medium, then compiled, interpreted, or otherwise processed in a suitable manner, if necessary, and then stored in a computer memory.

Embodiments of the present invention, for example, are described above with reference to block diagrams and/or operational illustrations of methods, systems, and computer program products according to embodiments of the invention. The functions/acts noted in the blocks may occur out of the order as shown in any flowchart. For example, two blocks shown in succession may in fact be executed substantially concurrently or the blocks may sometimes be executed in the reverse order, depending upon the functionality/acts involved.

While certain embodiments of the invention have been described, other embodiments may exist. Furthermore, although embodiments of the present invention have been described as being associated with data stored in memory and other storage mediums, data can also be stored on or read from other types of computer-readable media, such as secondary storage devices, like hard disks, floppy disks, or a CD-ROM, a carrier wave from the Internet, or other forms of RAM or ROM. Further, the disclosed methods' stages may be modified in any manner, including by reordering stages and/or inserting or deleting stages, without departing from the invention.

All rights including copyrights in the code included herein are vested in and the property of the Applicant. The Applicant retains and reserves all rights in the code included herein, and grants permission to reproduce the material only in connection with reproduction of the granted patent and for no other purpose.

While the specification includes examples, the invention's scope is indicated by the following claims. Furthermore, while the specification has been described in language specific to structural features and/or methodological acts, the claims are not limited to the features or acts described above. Rather, the specific features and acts described above are disclosed as example for embodiments of the invention.

What is claimed is:

1. A method for providing a context-sensitive user interface comprising:
displaying, on a display device, an input element in an application;
receiving a first text input from a user in the input element;
determining whether the first text input comprises an action token; and
in response to determining that the first text input comprises an action token, providing at least one suggested option associated with the action token to the user.

2. The method of claim 1, further comprising:
in response to determining that the first text input does not comprise an action token, determining whether the first text input comprises a partial match of at least one action token; and
in response to determining that the first text input comprises a partial match of at least one action token, displaying the at least one action token as a suggested option to the user.

3. The method of claim 1, further comprising:
receiving a plurality of action tokens from the user;
building a command from the plurality of action tokens; and
executing the command by the application.

4. The method of claim 1, wherein the at least one suggested option comprises a graphical option.

5. The method of claim 1, wherein the at least one suggested option comprises a text option.

6. The method of claim 1, wherein the action token comprises at least one of a plurality of predefined grammar terms.

7. The method of claim 6, wherein the plurality of predefined grammar terms are associated with at least one user interface language.

8. The method of claim 1, further comprising providing at least one suggested action token prior to receiving the first text input.

9. The method of claim 8, further comprising providing the at least one suggested action token in response to the user selecting the input element.

10. The method of claim 9, wherein the suggested action token is associated with a previously selected user interface element.

11. The method of claim 1, wherein the at least one suggested option is provided proximate to a current text input location.

12. A computer-readable medium which stores a set of instructions which when executed performs a method for providing a context-sensitive user interface, the method executed by the set of instructions comprising:
displaying a user interface element associated with an application;
providing at least one suggested action token;
receiving a text input from the user in the user interface element;
determining whether the text input comprises a complete action; and
in response to determining that the text input does not comprise a complete action, providing at least one suggested option to the user, wherein the at least one suggested option is associated with the text input.

13. The computer-readable medium of claim 12, wherein the suggested option is provided in a list displayed proximate to the user interface element.

14. The computer-readable medium of claim 12, wherein the text input comprises a partial match of the at least one suggested option.

15. The computer-readable medium of claim 14, further comprising searching a list of predefined tokens associated with the user interface element to provide the at least one suggested option comprising a partial match of the at least one suggested option.

16. The computer-readable medium of claim 12, further comprising:
in response to determining that the text input comprises a complete action, providing an option to execute the complete action as the at least one suggested option.

17. The computer-readable medium of claim 12, wherein the user interface element comprises an action input and wherein the action to be input comprises at least one of the following: a search action, a setting change, a data element creation, and a data element modification.

18. The computer-readable medium of claim 17, wherein the data element comprises at least one of the following: an e-mail message, a calendar appointment, an instant message, and a voicemail.

19. The computer-readable medium of claim 12, further comprising saving a completed action for re-use.

20. A system for providing a context-sensitive user interface, the system comprising:
a memory storage; and
a processing unit coupled to the memory storage, wherein the processing unit is operative to:
provide a text input user interface element associated with an application;
select a plurality of action tokens from a list of action tokens associated with the application, wherein being operative to select the plurality of action tokens comprises being operative to identify a currently active function of the application and select action tokens associated with the currently active function;
display, proximate to a current text input location in the user interface element, the plurality of action tokens in a context menu;
receive a first input from a user, wherein the first input comprises at least one of the following: a text entry in the user interface element and a selection of at least one of the plurality of action tokens;
determine whether the input comprises a complete action token;
in response to determining that the input does not comprise a complete action token, update the display of the plurality of action tokens to display a subset of the plurality of action tokens matching the input;
in response to determining that the input comprises a complete action token, display, proximate to the current text input location in the user interface element, a plurality of action options associated with the action token;
receive a second input from the user, wherein the second input comprises at least one of the following: a text entry in the user interface element and a selection of at least one of the plurality of action options;
determine whether the first input and the second input comprise a completed action; and
in response to determining that the first input and the second input comprise a completed action:
display an execute option proximate to the user interface element,
receive a third input from the user,
determine whether the third input comprises a selection of the execute option, and
in response to determining that the third input comprises a selection of the execute option, execute the completed action.
